(19) United States
(12) Patent Application Publication
(10) Pub. No.: US 2012/0256340 A1
(43) Pub. Date: Oct. 11, 2012

(54) ANTHROPIC STONE MATERIALS AND MIXES AND METHODS FOR MAKING SAME

(76) Inventor: JOAN M. BARGER, Manchester, NH (US)

(21) Appl. No.: 13/443,867

(22) Filed: Apr. 10, 2012

Related U.S. Application Data
(60) Provisional application No. 61/473,938, filed on Apr. 11, 2011.

(51) Int. Cl. C04B 32/00; B27N 5/00; B29C 59/02; C04B 14/00

(52) U.S. Cl. 264/119; 106/675; 264/109

(57) ABSTRACT

Disclosed is an anthropic stone material made by the introduction of water to a particulate casting mix comprising a lightweight component comprising a mixture of exfoliated vermiculite and a volcanic component selected from the group consisting of exfoliated perlite, pumice, and mixtures thereof, said exfoliated vermiculite and volcanic component mixed in a ratio range of 2:1 to 1:2 by volume, a cementitious component, and wherein said lightweight component and cementitious component are mixed in a ratio range of from about 3:2 to 2:3 by volume.

### CROSS-REFERENCE TO RELATED APPLICATIONS

This patent application claims priority at least under 35 U.S.C. 119(e) from U.S. provisional patent application No. 61/473,938, filed 11 APR. 2011, the disclosures of which are incorporated herein by reference in their entirety.

### BACKGROUND OF THE INVENTION

1. Field of the Invention

The present invention relates to anthropic stone materials and the particulate mix compositions and casting materials from which they are made, comprising a cementitious material, exfoliated vermiculite, and volcanic components.

2. Description of the Related Art

It is known to make anthropic rock with an aged or ancient appearance, the most common being hypertufa, a cementitious mix typically comprising Portland cement, perlite, and peat moss.

Hypertufa was invented sometime in the early 19^{th} century in Europe by gardeners of Alpine plants. These gardeners favored ancient stone watering troughs, artfully carved, for such plants, but by the 1800's such artifacts were rare and expensive. Hypertufa was a carving and casting media that offered the look of ancient weathered stone via a composite upon which moss would grow, thereby enhancing the aged appearance.

Hypertufa objects are very porous to water, especially after the peat moss component decays, and tend to rapidly erode over the years. Water entering the porous material will freeze and expand in winter, gradually destroying the material over years of use. The present invention is a superior substitute for hypertufa in that it is significantly more resistant to erosion and presents and maintains the appearance of ancient carved stone and further presenting a suitable substrate for moss growth.

It is also known to mix exfoliated vermiculite to Portland cement or calcium silicates in general to produce fireproof building materials as a substitute for asbestos, such as is described in Zimmerman, U.S. Pat. No. 4,075,804, issued 28 FEB. 1974. Typically, the prior art uses at least about 7% of vermiculite by weight in these formulations.

Carkner, U.S. Pat. No. 6,290,769, issued 18 SEP. 2001, discloses a 1:4 ratio by weight (i.e., 20% by weight) of lightweight components comprising vermiculite and perlite (in a weight ratio no greater than 2:1) to a cementitious mixture of Portland cement, plaster of Paris, and terra alba. The lightweight material disclosed by Carkner is useful for patching roof surfaces.

### SUMMARY OF THE INVENTION

Disclosed is an anthropic stone material made from a particulate mix that upon addition of water forms a plastic or liquid casting material. Upon hardening by hydration, the resulting anthropic stone casting has the appearance of ancient stone and is lightweight, strong, and waterproof.

The mixture is obtained by blending together a lightweight component comprising a particulate mix of exfoliated vermiculite and a volcanic material such as pumice and/or exfoliated perlite, with a heavy component comprising a cementitious material. After addition of water, the mixture converts into a plastic or liquid casting medium that hardens upon hydration.

### BRIEF DESCRIPTION OF THE DRAWINGS

The above objectives and advantages of the present invention will become more apparent by describing in detail preferred embodiments thereof with reference to the attached drawings in which:

FIG. 1 is a front view of an objet d'art produced by casting.

FIG. 2 is a rear view of the objet d'art of FIG. 1 showing the surface texture of the finished casting medium of the invention.

FIG. 3 is a close-up view of a small area of the back surface of the objet d'art of FIG. 2, showing a patch of material measuring about 1.25″ square.

### DETAILED DESCRIPTION OF THE PREFERRED EMBODIMENTS

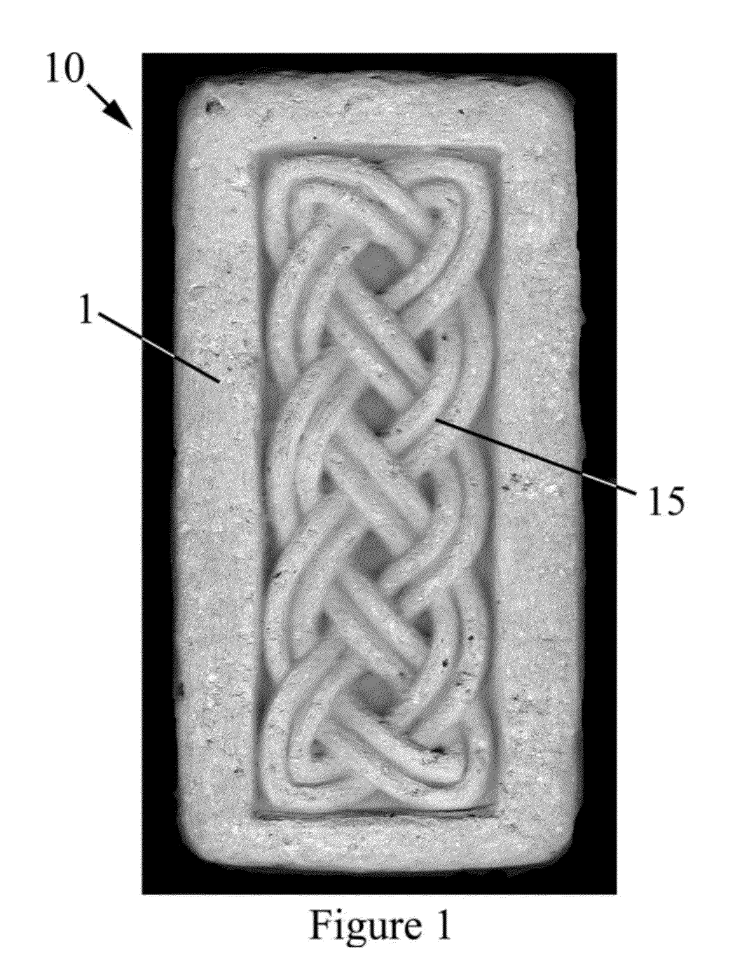

Referring to FIG. 1, there is shown a cast object 10, in this case an objet d'art, having patterns 15 molded in relief in the anthropic stone 1 of the invention.

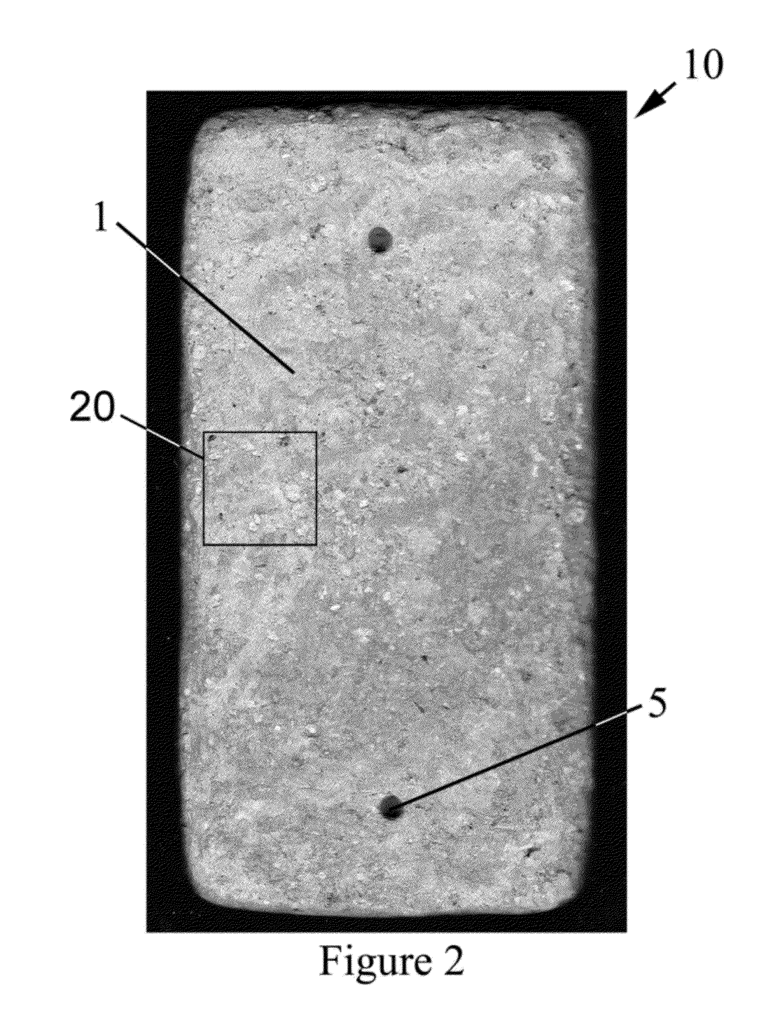

The texture of the anthropic stone 1 is perhaps more clearly appreciated by observing the rear of the object 10 as shown in FIG. 2. The two dark disk-shaped areas are mounting holes 5, which may be drilled or cast. Though the anthropic stone 1 presents with the appearance of real geologic stone, it is far more lightweight and suitable for hanging, if desired, for reasons that will become apparent below.

The creation of the anthropic stone 1 of the invention begins with the creation of a particulate casting mix comprising a lightweight component and a cementitious component, the latter for the purpose of binding the components together. The lightweight component is a mixture of exfoliated vermiculate and volcanic stone, namely exfoliated perlite and/or pumice.

Exfoliation is the process of heating a geologic material so as to cause it to expand. When natural vermiculite is heated it expands into a mass of wormlike-shaped particles, greatly reducing its density. This property was first discovered in Millbury, Mass. and earned the mineral its name from the Latin vermiculare, meaning “to breed worms.” Essentially fireproof, vermiculite is widely used as an asbestos substitute. Vermiculite is translucent, looks somewhat like mica, but often bronzy, and is relatively soft at 1.5 to 2.0 on the Mohs scale. The exfoliated version of vermiculite is the common commercial form and has a bulk density typically ranging from 4 to 10 pounds per cubic foot, or about 7 lb/ft^{3.}

Perlite is also exfoliated in its common commercial form. Perlite is a volcanic glass having water trapped within it. When heated, the water vaporizes causing the softened glass to bubble out creating a brilliant white particulate with a bulk density of about 2 to 9 pounds per cubic foot, or about 6 lb/ft^{3.}

Pumice is an igneous volcanic rock commonly used as a lightweight aggregate in concrete blocks. It has a white appearance—though not as brightly white as perlite—and a bulk density ranging from about 12 to 37 pounds per cubic foot, or about 25 lb/ft³. Pumice is naturally exfoliated by volcanic heat and needs no further heat processing of its natural form, which typically presents with a porosity of about 90%. It is the only rock that floats on water, though is porous enough that it will eventually sink.

The most common cementitious material for use as the cementitious component of the invention is Portland cement. Pozzolan is another useful cementitious material for use in the present invention, but is not nearly as immediately available as Portland cement. The density of Portland cement varies according to particle size and packing, but it is a standard practice in the industry to consider a freshly packed 94 lb bag to be 1 cubic foot.

The method of producing the anthropic tone of the invention begins with the creation of a particulate casting mix comprising a lightweight component and a cementitious component. To the particulate casting mix is added water, forming a plastic or liquid casting material, suitable for introducing into a mold. When cured, the anthropic stone of the invention is obtained.

The lightweight component is obtained by mixing exfoliated vermiculite and at least one particulate volcanic stone in a ratio range of from about 2:1 to about 1:2 by volume. The particulate volcanic stone is exfoliated perlite, pumice, or a mixture thereof

The lightweight component is then mixed with a cementitious component in a ratio range of about 3:2 to about 2:3 by volume.

It should be noted that vermiculite is not cheap as of this writing and it may be expected that economic factors will influence the preferred mix ratios as well as esthetic ones and are subject to change. A preferred mix ratio that is both economical and esthetically pleasing is a 1:2:3 ratio by volume of exfoliated vermiculite to exfoliated perlite to Portland cement. In other words, the exfoliated vermiculite is mixed with exfoliated perlite in about a 1:2 ratio by volume to form the lightweight component and the lightweight component thus obtained is mixed with Portland cement in about a 1:1 ratio by volume. The resulting casting mix will be about 6 or 7 percent lightweight component by weight.

Preferably, the amount of water added is enough to bring the casting material to a plastic consistency, such as the consistency of a cookie dough. The exact amount of water will vary according to the quality of the components, namely the particulate size, purity, and degree of exfoliation. Typical cookie doughs will have elongational viscosities on the order of 10⁵ to 10⁶ Pa·S. Without undue experimentation, the artist will have little difficulty getting the “feel” of the right consistency because the precise elongational viscosity of the casting material is not critical and is free to experiment with viscosities outside the “cookie range,” by orders of magnitude as is an artist's prerogative.

The casting material is then molded, either by hand or pressing into a mold or any other means, and allowed to begin setting (i.e., hydrating).

After about two to four hours, the molded object will be an intermediate material that is hardened enough to remove from the mold, yet not completely hydrated. This allows for the optional, yet desirable, step of wire brushing the surface while it is still soft. This step has the effect of imparting an aged and weathered look to the object and revealing particles of vermiculite and volcanic stone beneath the surface, enhancing its appearance. When fully cured (hydrated), the anthropic stone material of the invention is obtained, formed to the mold.

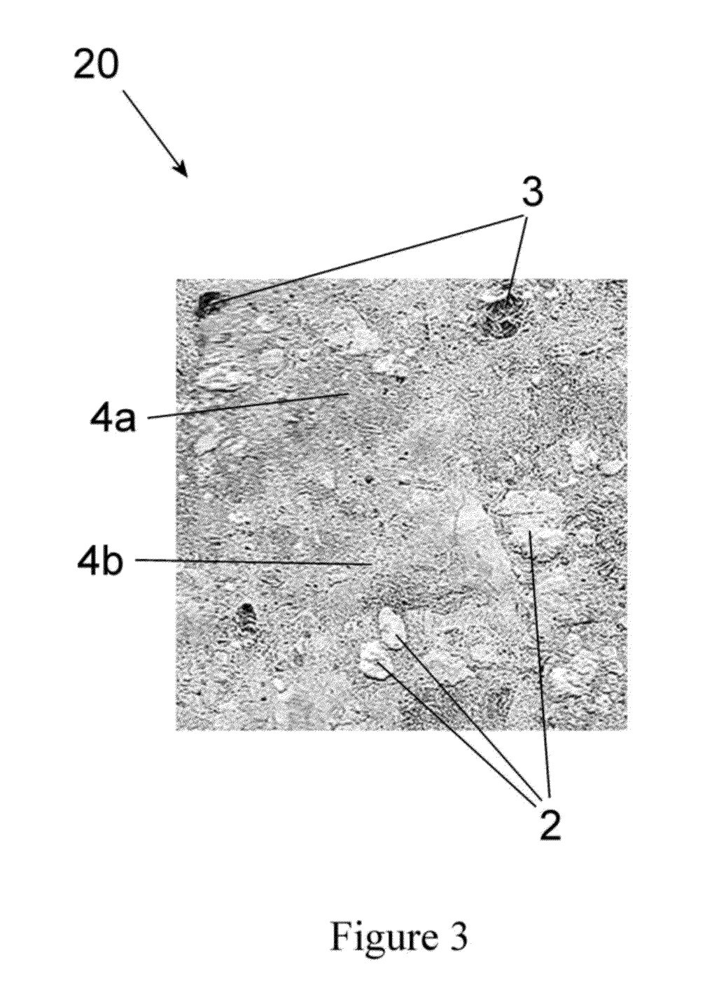

Referring to FIG. 3, there is shown a close-up image 1′ of the wire brushed anthropic stone surface of FIG. 2. The image shown is approximately 1.25″ square and derived from a desk scanner. Vermiculate flakes 3 appear dark in the scanned image, but appear silvery when seen by the naked eye, with the texture of mica yet the color of polished silver or aluminum. The actual reflection pattern of the vermiculite flakes 3 change with angle and lighting as the viewer tilts and turns the object, occasionally sparkling. Perlite fragments 2 appear as white rough-surfaced areas. The wire-brushed Portland cement 4 presents as irregular dark 4a and light 4b surfaces, very similar in appearance to the moon. The light surfaces 4b appear more often to be depressed relative to the dark surfaces 4a, though not always.

Although the invention has been described with reference to particular embodiments, it will be apparent to one of ordinary skill in the art that modifications to the described embodiments may be made without departing from the spirit and scope of the invention.

What is claimed is:

1. A particulate casting mix comprising:
a lightweight component comprising a mixture of exfoliated vermiculite and at least one particulate volcanic stone selected from the group consisting of exfoliated perlite, pumice, and mixtures thereof, said exfoliated vermiculite and volcanic component mixed in a ratio range of 2:1 to 1:2 by volume;
a cementitious component; and
wherein said lightweight component and cementitious component are mixed in a ratio range of 3:2 to 2:3 by volume.

2. The particulate casting mix of claim 1 wherein the lightweight component comprises a mixture of exfoliated vermiculite, particulate volcanic stone, and cementitious component in a ratio of about 1:2:3.

3. The particulate casting mix of claim 2 wherein the particulate volcanic stone is exfoliated perlite and the cementitious component is Portland cement.

4. The particulate casting mix of claim 1 wherein said cementitious component is Portland cement.

5. A casting material comprising water and the particulate casting mix of claim 1.

6. An anthropic stone material comprising the hydrated particulate casting mix of claim 1.

7. An intermediate material comprising the partially hydrated particulate casting mix of claim 1.

8. An anthropic stone material comprising the hydrated wire brushed intermediate material of claim 7.

9. An objet d'art comprising the anthropic stone material of claim 8.

10. A method of making an anthropic stone material comprising the steps of:
mixing exfoliated vermiculite, exfoliated perlite, and Portland cement in a ratio of about 1:2:3 to create a particulate casting mix,
adding water to the particulate casting mix sufficient to create a casting material,
molding the casting material to a desired shape,
allowing the casting material to partially hydrate to an intermediate material, and
allowing the intermediate material to fully hydrate.

11. The method of claim 10 further comprising the step of wire brushing the intermediate material.
